(19) United States
(12) Patent Application Publication
(10) Pub. No.: US 2012/0038333 A1
(43) Pub. Date: Feb. 16, 2012

(54) Coil-less stepdown power transformer

(76) Inventor: Gene-Schie Horn, Durban (ZA)

(21) Appl. No.: 12/805,609

(22) Filed: Aug. 10, 2010

(51) Int. Cl. G05F 1/10

(52) U.S. Cl. 323/282

(57) ABSTRACT

This invented device uses mainly two circuits; namely, electronic switch and arithmetic average circuit to average the switched on/off source voltage, AC or DC, down to the load-needed lower value. This device is not of a high frequency coil transformer circuit, yet not of a resistive or reactive voltage drop or dividing circuit. The stepdown ratio of this device is soft-adjustable, and hence the voltage stabilization can be easily implemented inside itself. Inherently, the switching device is light, small, and high power efficiency. Theoretically, the high efficiency of this device is because this device has no no-load loss and a load loss=(constant saturation voltage)×(load current) if BJT or IGBT switch used, while the coil transformer has a no-load loss (iron loss) and a load loss (copper loss). This device can replace most coil transformers to economize the use of energy, copper and iron.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

### Technical Area of the Patent

H02M3, Conversion of dc power input into dc power output or

H02M5, Conversion of ac power input into ac power output, e.g. for change of voltage, for change of frequency, for change of number of phases

### Background Knowledge or Information

An application of Power Electronic Circuits, basically and mostly electronic switching circuits (possibly electronic incorporated with mechanical switching devices especially for high voltage and high power case), and arithmetic average device or circuit. The switching circuit is to switch on or off the source voltage at a certain on/off time ratio; the arithmetic average circuit is to average this switched source voltage to an average value which is linearly related to the on/off time ratio. This is a revolutionary non-electrical 3rd generation technique besides early electric and magnetic means.

### Specific Problems Involved in the Prior Art

Prior to this, the art of this subject is either electric or magnetic. Electrically, it is of a resistive or a reactive voltage drop or dividing circuit, which is not practical for power purposes but practical only in cases for low power electronic use. Magnetically, it is of magnetic coil coupling circuit or high frequency coil transformer circuit (not for voltage change from AC to AC), which is now in wide use. Relatively, these magnetic coil devices are low efficiency, weight heavy, volumetric bulk, and consuming big quantity of copper and iron. Theoretically, the efficiency of the coil transformer is worse than this new invented device, as the coil transformer has a no-load loss (iron loss) and a load loss (copper loss), which is proportional to the power 2 of the load current, while this device has no no-load loss and a load loss=(constant saturation voltage)×(load current) if BJT or IGBT or even mechanical switch used.

### BRIEF SUMMARY OF THE INVENTION

Uses electronic power switch to connect or disconnect source voltage at a certain on/off time ratio to an arithmetic average unit; this average unit averages the on/off source voltage and gains a low averaged load voltage, which is linearly related to the on/off time ratio. To adjust the load voltage stepdown ratio, adjust easily this on/off time ratio—this is soft-adjustable. If a voltage regulator is to be included to stabilize the load voltage, a PWM circuit and a closed loop control circuit are easily implemented into the system.

Inherently, the switching circuit and the average circuit are small in volume and weight, and low consumption of power as well as natural resources, copper and iron. Hence this new invention is environmentally friendly.

### BRIEF DESCRIPTION (OF THE SEVERAL VIEWS) OF THE DRAWING

An input source voltage is on/off switched at a fixed frequency 1000*(source frequency) and a certain duty ratio, then averaged, and finally fed to the low voltage load. The stepdown voltage ratio equals to the duty ratio. The output voltage can be stabilized by a closed loop control of a pulse width (duty ratio) modulation circuit.

### DETAILED DESCRIPTION OF THE INVENTION

As far as the applications concerned, this new invented device is completely compatible to the wide used stepdown coil transformers.

Fore-Technology:

Magnetic inductive coil coupling technique.

Content of the Patent:

Use of on/off switch and arithmetic average techniques to derive a low load voltage from high voltage power source, and the load voltage stepdown ratio is soft-adjustable.

Practice of the Patent Techniques:

Uses electronic power switch to connect or disconnect power source voltage to an arithmetic average circuit; this average circuit averages the on/off source volt-age and gains a lower averaged load voltage. The on/off time ratio of the source voltage determines the averaged value or load voltage. To adjust the load voltage stepdown ratio, adjust easily this on/off time ratio.

Here a voltage regulator is included. From the load voltage terminal, the volt-age regulator unit can detect if load voltage is stabilized to a certain reference value. If not, a correcting signal is fed to the PWM (pulse width modulator) unit to adjust the on/off time ratio and finally to adjust the load voltage to a stabilized value.

Description of the Diagram:

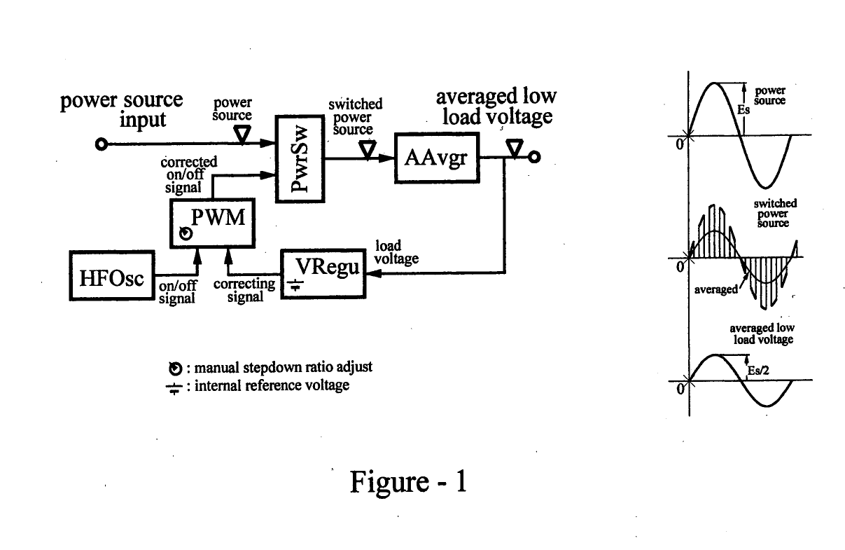

Refer to the only circuit block diagram, FIG. 1, at a separate sheet of Drawing. A fixed high frequency on/off signal from HFOsc unit is fed into PWM unit. PWM unit accepts this on/off signal plus the correcting signal from VRegu unit, a voltage regulator. The correcting signal is to adjust the on/off time ratio and finally to adjust the load voltage to a stabilized value. PWM outputs a corrected on/off signal to PwrSw unit, an electronic power switch, and further the PwrSw unit under the control of the corrected on/off signal switches the source voltage on or off to the AAvgr unit, an arithmetic average circuit. This AAvgr unit averages the on/off switched source voltage to gain the averaged voltage to the load, or low load voltage. This averaged load voltage is related to the on/off time ratio. VRegu unit accepts load voltage and compares the load voltage with an inside reference to produce a correcting signal fed into PWM.

Legend for the Diagram:

HFOsc:

High frequency oscillator unit, outputs fixed high frequency on/off signal.

High frequency must be higher than ten times the power source frequency.

PWM:

Pulse width modulation unit, adjusts on/off time ratio, inputs fixed frequency on/off signal and correcting signal, and outputs corrected on/off signal.

PwrSw:

Power switch unit, performs switch-on or -off from power source to load, inputs source voltage and corrected on/off signal, and outputs switched source voltage.

AAvgr:

Arithmetic average unit, averages the switched source voltage to get arithmetic average value or load voltage. This average value is related to the switch on/off time ratio. The unit inputs switched source voltage and outputs averaged low load voltage.

VRegu:

Voltage regulate unit, outputs correcting signal after compared with the inside reference voltage to PWM unit to adjust switch on/off time ratio and finally to stabilize load voltage to the reference. The unit inputs load voltage and outputs correcting signal.

### Drawings (When Necessary)

At a Separate Page

### Sequence Listing (When Necessary)

Not Applicable

### Oath or Declaration

At a Separate Form

1. Any equipment which converts voltage source, AC or DC, into a lower load voltage in such a way that a source voltage is, by any switch device, connected/disconnected at a certain ratio of on/off time to any arithmetic average device or circuit to average down the switched on/off source voltage to the load-needed lower value; hence, any such equipment of any different on/off frequency or on/off time ratio is within the extent of the patent; and hence, in the case that this invented equipment is applied as a sub-unit in any system, the sub-unit is within the extent of the patent.
